(19) United States
(12) Patent Application Publication
(10) Pub. No.: US 2011/0137431 A1
(43) Pub. Date: Jun. 9, 2011

(54) VALUABLE MEDIA MANAGEMENT SYSTEM AND VALUABLE MEDIA MANAGEMENT METHOD "

(76) Inventors: Kazuhiro Doi, Hyogo-Ken (JP); Koichi Nishida, Hyogo-Ken (JP)

(21) Appl. No.: 12/737,737

(22) PCT Filed: Aug. 12, 2008
(86) PCT No.: PCT/JP2008/064489

§ 371 Date: Feb. 11, 2011

(51) Int. Cl. G05B 15/00

(52) U.S. Cl. 700/75

(57) ABSTRACT

To reduce a burden of a person in charge who uses a valuable media management system including a plurality of valuable media handling machines having the same valuable-media processing function, and control units that correspond to the respective valuable media handling machines. Each of the valuable media handling machine has a state detecting unit for detecting the state of the valuable media handling machine. Each of the control unit has a corresponding machine control function for working the valuable media handling machine that corresponds to the own control unit, as well as a non-corresponding machine control function for working another valuable media handling machine other than the valuable media handling machine that corresponds to the own control unit. The corresponding machine control function and the non-corresponding machine control function can be switched depending on a change of the state of the valuable media handling machine detected by the state detecting unit.

### FIELD OF THE INVENTION

The present invention relates to a valuable media management system and a valuable media management method. In particular, the present invention relates to a valuable media management system including a plurality of valuable media management apparatuses each of which is composed of a valuable media handling machine and a control unit that corresponds to the valuable media handling machine, and a valuable media management method in this system. The valuable media handling machine is configured to perform a receiving process of valuable media and a storing process thereof. The control unit has an operation unit to be operated for working the valuable media handling machine.

### BACKGROUND ART

Valuable media management apparatuses have been conventionally installed in backyards of department stores, supermarket stores, and so on. The valuable media management apparatus is configured to recognize and count valuable media such as money or coupons that have been collected from a cash register, and to temporarily store the valuable media.

The valuable media management apparatus of this type is also installed in a backyard of a financial institution such as a bank, and is used to recognize, count and to temporarily store money collected from a teller machine or the like.

As the valuable media management apparatus of this type, there is generally known a valuable media management apparatus including: a pair of a valuable media handling machine (hereinafter referred to simply as “handling machine”) configured to perform a receiving process of valuable media, a recognizing process thereof and a storing process thereof; and a control unit (hereinafter referred to as “terminal”) configured to control a behavior of the handling machine based on an operation of a cashier or an accounting staff (hereinafter referred to generically as “person in charge”) who performs a depositing operation and the like (see, Patent Document 1, for example).

In a valuable media management system using the valuable media management apparatus including the pair of the terminal and the handling machine, valuable media are managed as follows. Namely, a person in charge operates an operation unit of the terminal so as to put valuable media collected from a cash register or the like into the handling machine. After the handling machine has performed a recognition process of the valuable media, a counting process thereof and so on, the valuable media are temporarily stored in the handling machine.

Patent Document 1: JP3330801B

### DISCLOSURE OF THE INVENTION

However, since the aforementioned conventional valuable media management system includes the terminal and the handling machine as a set, in a store where the number of valuable media to be processed is extremely large, there is a possibility that a burden on a person in charge might increases.

That is to say, in the one valuable media management apparatus, the number of valuable media capable of being stored in the handling machine is limited. Thus, in a store that manages valuable media whose number is so large that they cannot be stored in the one valuable media management apparatus, it is necessary to install the plurality of valuable media management apparatuses.

In a case the plurality of valuable media management apparatuses are installed, when the number of valuable media that have been collected by each person in charge so as to be put into each of the valuable media management apparatuses is the number of valuable media that can be stored in each valuable media management apparatus, it poses no problem in terms of the burden on each person in charge.

However, when only one person in charge works, or when any one of persons in charge cannot put valuable media into the valuable media management apparatus, one person in charge must operate the plurality of valuable media management apparatuses.

In this case, the one person in charge operates the terminal of the valuable media management apparatus for which he/she is responsible and puts valuable media for which he/she is responsible into the handling machine corresponding to the terminal, and thereafter this person in charge must operate the terminal of the valuable media management apparatus for which another person is responsible and put valuable media for which another person is responsible into the handling machine corresponding to the terminal. Thus, there occurs a problem in that a burden on the person in charge increases.

In addition, when the number of valuable media that have been collected by one person in charge exceeds the number of valuable media that can be stored in one handling machine, this person in charge must separately put the collected valuable media into the plurality of valuable media handling machines. Also in this case, since the person in charge must operate the plurality of terminals and put the valuable media to the respective handling machine corresponding to the terminals, there occurs a problem in that a burden on the person in charge increases.

Thus, the present invention has been made in order to solve the above conventional object (problem). The object of the present invention is to provide a valuable media management system capable of restraining increase of a burden on a person in charge, even when a plurality of valuable media management apparatuses having the same valuable-media processing function are installed.

In order to solve the aforementioned problem and to achieve the object, the invention according to claim 1 provides a valuable media management system comprising a plurality of valuable media management apparatuses each including: a valuable media handling machine configured to process valuable media; and a control unit that corresponds to the valuable media handling machine, the control unit having an operation unit configured to be operated for working the valuable media handling machine; at least one valuable media handling machine among the plurality of valuable media handling machines has a valuable-media processing function that is the same as that of another valuable media handling machine; each of the valuable media handling machine has a state detecting unit configured to detect a state of the valuable media handling machine; and each of the control unit has a corresponding machine control function for working the valuable media handling machine that corresponds to the own control unit, as well as a non-corresponding machine control function for working another valuable media handling machine other than the valuable media handling machine that corresponds to the own control unit, and the corresponding machine control function and the non-corresponding machine control function are capable of being switched depending on a change of the state of the valuable media handling machine detected by the state detecting unit.

In addition, in the invention according to claim 2, when the corresponding machine control function is set, the control unit transmits a process command to the valuable media handling machine that corresponds to the own control unit, such that valuable media are processed by the valuable media handling machine; and when the non-corresponding machine control function is set, the control unit transmits a process request to another control unit, such that valuable media are processed by the valuable media handling machine that corresponds to said other control unit.

In addition, in the invention according to claim 3, when the control unit receives the process request transmitted from another control unit, the control unit allows the valuable media handling machine that corresponds to the own control unit to be worked by said other control unit that has transmitted the process request.

In addition, in the invention according to claim 4, the valuable media handling machine includes: a valuable media receiving unit configured to receive valuable media; a recognition unit configured to recognize the valuable media received by the valuable media receiving unit; and a storing unit configured to store the valuable media recognized by the recognition unit.

In addition, in the invention according to claim 5, the control unit is configured to be capable of switching the corresponding machine control function and the non-corresponding machine control function, based on an operation of the operation unit.

In addition, in the invention according to claim 6, the state detecting unit is configured to detect the number of valuable media stored in the storing unit, as a state of the valuable media handling machine.

In addition, in the invention according to claim 7, the control unit includes a storage possibility judgment unit configured to judge whether valuable media to be put into the valuable media handling machine that corresponds to the own control unit are capable of being stored in the storing unit; and when the storage possibility judgment unit judges that the valuable media are not capable of being stored, the control unit transmits a process request, requesting storage of the valuable media, to the control unit that corresponds to another valuable media handling machine capable of storing the valuable media.

In addition, in the invention according to claim 8, the control unit includes an informing unit configured to inform of the other valuable media handling machine capable of storing the valuable media, when the storage possibility judgment unit judges that the valuable media are not capable of being stored.

In addition, in the invention according to claim 9, the valuable media handling machine includes a discharge unit configured to discharge valuable media stored in the storing unit, the valuable media being discharged based on an operation of the operation unit; the control unit includes a discharge possibility judgment unit configured to judge, when a discharge operation for discharging valuable media is performed by the operation unit, whether valuable media corresponding to the discharge operation are capable of being discharged or not; and when the discharge possibility judgment unit judges that the valuable media are not capable of being discharged, the control unit transmits a process request requesting discharge of valuable media to the control unit that corresponds to another valuable media handling machine capable of discharging valuable media corresponding to the discharge operation.

In addition, in the invention according to claim 10, the control unit includes an informing unit configured to inform of the other valuable media handling machine capable of discharging the valuable media corresponding to the discharge operation, when the discharge possibility judgment unit judges that the valuable media are not capable of being discharged.

In addition, in the invention according to claim 11, the state detecting unit detects whether the valuable media handling machine should undergo a maintenance operation or not, and when the state detecting unit detects that the valuable media handling machine should undergo a maintenance operation, the control unit informs of another valuable media handling machine that does not require a maintenance operation.

In addition, the invention according to claim 12 provides a valuable media management method comprising: controlling a corresponding machine, by means of a control unit that corresponds to a valuable media handling machine configured to process valuable media and controls a behavior of the valuable media handling machine, to process valuable media by the valuable media handling machine that corresponds to the control unit; controlling a non-corresponding machine, by means of the control unit, to process valuable media by another valuable media handling machine having the same valuable-media processing function as that of the valuable media handling machine; and switching the controlling of a corresponding machine and the controlling of a non-corresponding machine by the control unit depending on a state of the valuable media handling machine that corresponds to the control unit.

According to the present invention, there is provided a valuable media management system comprising a plurality of valuable media management apparatuses each including: a valuable media handling machine configured to process valuable media; and a control unit that corresponds to the valuable media handling machine, the control unit having an operation unit configured to be operated for working the valuable media handling machine; at least one valuable media handling machine among the plurality of valuable media handling machines has a valuable-media processing function that is the same as that of another valuable media handling machine; each of the valuable media handling machine has a state detecting unit configured to detect a state of the valuable media handling machine; and each of the control unit has a corresponding machine control function for working the valuable media handling machine that corresponds to the own control unit, as well as a non-corresponding machine control function for working another valuable media handling machine other than the valuable media handling machine that corresponds to the own control unit, and the corresponding machine control function and the non-corresponding machine control function are capable of being switched depending on a change of the state of the valuable media handling machine detected by the state detecting unit. Thus, the present invention can provide a valuable media management system capable of restraining increase of a burden on a person in charge, even when a plurality of valuable media management apparatuses having the same valuable-media processing function are installed.

In addition, according to the present invention, when the corresponding machine control function is set, the control unit transmits a process command to the valuable media handling machine that corresponds to the own control unit, such that valuable media are processed by the valuable media handling machine; and when the non-corresponding machine control function is set, the control unit transmits a process request to another control unit, such that valuable media are processed by the valuable media handling machine that corresponds to said other control unit. Thus, by operating a certain control unit, a process request can be transmitted to another control unit.

Therefore, the present invention can provide a valuable media management system capable of restraining increase of a burden on a person in charge, even when a plurality of valuable media management apparatuses having the same valuable-media processing function are installed.

In addition, when the control unit receives the process request transmitted from another control unit, the control unit allows the valuable media handling machine that corresponds to the own control unit to be worked by said other control unit that has transmitted the process request. Thus, by operating a certain control unit, the valuable media handling machine corresponding to another control unit can process valuable media. Therefore, the present invention can provide a valuable media management system capable of restraining increase of a burden on a person in charge, even when a plurality of valuable media management apparatuses having the same valuable-media processing function are installed.

In addition, according to the present invention, the valuable media handling machine includes: a valuable media receiving unit configured to receive valuable media; a recognition unit configured to recognize the valuable media received by the valuable media receiving unit; and a storing unit configured to store the valuable media recognized by the recognition unit. Thus, by operating a certain control unit, the valuable media handling machine corresponding to another control unit can perform the recognition process of the same valuable media and the storing process thereof. Therefore, the present invention can provide a valuable media management system capable of restraining increase of a burden on a person in charge, even when a plurality of valuable media management apparatuses having the same valuable-media processing function are installed.

In addition, according to the present invention, the control unit is configured to be capable of switching the corresponding machine control function and the non-corresponding machine control function, based on an operation of the operation unit. Thus, by operating the operation unit of a certain control unit, the valuable media handling machine corresponding to another control unit can process valuable media. Therefore, the present invention can provide a valuable media management system capable of restraining increase of a burden on a person in charge.

In addition according to the present invention, the state detecting unit is configured to detect the number of valuable media stored in the storing unit, as a state of the valuable media handling machine. Thus, depending on the number of valuable media stored in the storage unit of each paper sheet handling machine, the valuable media handling machine corresponding another control unit can suitably process valuable media. Therefore, the present invention can provide a valuable media management system capable of restraining increase of a burden on a person in charge.

In addition, according to the present invention, the control unit includes a storage possibility judgment unit configured to judge whether valuable media to be put into the valuable media handling machine that corresponds to the own control unit are capable of being stored in the storing unit; and when the storage possibility judgment unit judges that the valuable media are not capable of being stored, the control unit transmits a process request, requesting storage of the valuable media, to the control unit that corresponds to another valuable media handling machine capable of storing the valuable media. Thus, when valuable media whose number is so large that they cannot be stored in the one valuable media handling machine should be stored, a person in charge operates only one of the control units so that the valuable media can be stored in the plurality of valuable media handling machines. Therefore, the present invention can provide a valuable media management system capable of restraining increase of a burden on a person in charge.

In addition, according to the present invention, the control unit includes an informing unit configured to inform of the other valuable media handling machine capable of storing the valuable media, when the storage possibility judgment unit judges that the valuable media are not capable of being stored. Thus, a person in charge can easily know another valuable media handling machine capable of storing valuable media that could not be stored in the one valuable media handling machine. Therefore, the present invention can provide a valuable media management system capable of restraining increase of a burden on a person in charge.

In addition, according to the present invention, the valuable media handling machine includes a discharge unit configured to discharge valuable media stored in the storing unit, the valuable media being discharged based on an operation of the operation unit; the control unit includes a discharge possibility judgment unit configured to judge, when a discharge operation for discharging valuable media is performed by the operation unit, whether valuable media corresponding to the discharge operation are capable of being discharged or not; and when the discharge possibility judgment unit judges that the valuable media are not capable of being discharged, the control unit transmits a process request requesting discharge of valuable media to the control unit that corresponds to another valuable media handling machine capable of discharging valuable media corresponding to the discharge operation. Thus, even when the valuable media handling machine corresponding to the control unit that has been operated by a person in charge cannot discharge valuable media, the person in charge can receive valuable media discharged from another valuable medium handling machine without operating another control unit. Therefore, the present invention can provide a valuable media management system capable of restraining increase of a burden on a person in charge.

In addition, according to the present invention, the control unit includes an informing unit configured to inform of the other valuable media handling machine capable of discharging the valuable media corresponding to the discharge operation, when the discharge possibility judgment unit judges that the valuable media are not capable of being discharged. Thus, even when the valuable media handling machine corresponding to the control unit that has been operated by a person in charge cannot discharge valuable media, the person in charge can easily know another valuable media handling machine capable of discharging valuable media. Therefore, the present invention can provide a valuable media management system capable of restraining increase of a burden on a person in charge.

In addition, according to the present invention, the state detecting unit detects whether the valuable media handling machine should undergo a maintenance operation or not, and when the state detecting unit detects that the valuable media handling machine should undergo a maintenance operation, the control unit informs of another valuable media handling machine that does not require a maintenance operation. Since a person in charge can easily know another valuable media handling machine which does not require a maintenance operation, the present invention can provide a valuable media management system capable of restraining increase of a burden on a person in charge.

In addition, according to the present invention, there is provided a valuable media management method including: controlling a corresponding machine, by means of a control unit that corresponds to a valuable media handling machine configured to process valuable media and controls a behavior of the valuable media handling machine, to process valuable media by the valuable media handling machine that corresponds to the control unit; controlling a non-corresponding machine, by means of the control unit, to process valuable media by another valuable media handling machine having the same valuable-media processing function as that of the valuable media handling machine; and switching the controlling of a corresponding machine and the controlling of a non-corresponding machine by the control unit depending on a state of the valuable media handling machine that corresponds to the control unit. Thus, the present invention can provide a valuable media management method capable of restraining increase of a burden on a person in charge, even when a plurality of valuable media management apparatuses having the same valuable-media processing function are installed.

### BRIEF DESCRIPTION OF THE DRAWINGS

FIG. 1 is an explanatory view showing an overall structure of a valuable media management system in one embodiment.

FIG. 2 is an explanatory view showing structures of a terminal and a handling machine.

FIG. 3 is an explanatory view showing examples of display by the terminal.

FIG. 4 is a flowchart showing processes performed by a main control unit of the terminal.

FIG. 5 is a flowchart showing processes performed by a sub control unit of the handling machine.

S valuable media management system

1 first system

2 first handling machine

3 first terminal

100 second system

102 second handling machine

103 second terminal

11, 111 displaying and operating unit

12 main control unit

21 sub control unit

### DETAILED DESCRIPTION OF THE INVENTION

Herebelow, a preferred embodiment of a valuable media management system and a valuable media management method according to the present invention will be described with reference to the accompanying drawings.

Given herein as an example of a valuable media management system to describe the embodiment is a valuable media management system including two valuable media management apparatuses each having: a valuable media handling machine (hereinafter referred to simply as “handling machine”) configured to handling a valuable media of the same kind (herein, banknotes issued by Bank of Japan); and a control unit (hereinafter referred to simply as “terminal”) provided to correspond to the handle machine, the control unit being configured to control a behavior of the corresponding handling machine.

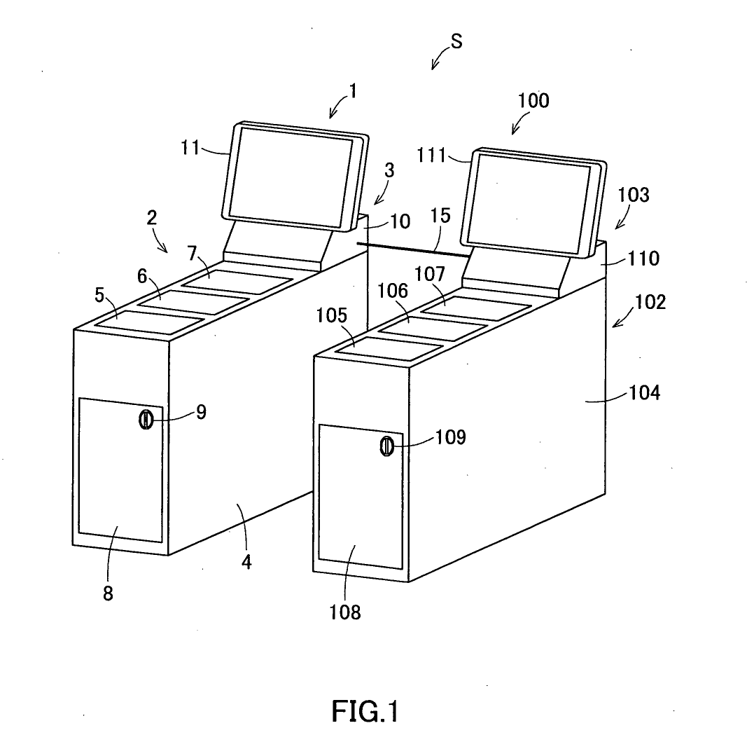

FIG. 1 is an explanatory view showing an overall structure of a valuable media management system in this embodiment. In the below description, a valuable media management apparatus located on the left side in FIG. 1 is referred to as “first system 1”, and a valuable media management apparatus located on the right side is referred to as “second system 100”. A system as a whole that is composed of the first system 1 and the second system 100 is referred to as “valuable media management system S”.

In addition, this embodiment is described in which a terminal of the first system 1 is referred to as “first terminal 3”, a handling machine of the first system 1 is referred to as “first machine 2”, a terminal of the second system 100 is referred to as “second terminal 103”, and a handling machine of the second system 100 is referred to as “second machine 102”.

The valuable media management system S shown in FIG. 1 is a system that is installed in a backyard or a cash room of a department store, a supermarket, a bank and so on.

The valuable media management system S is used by a register cashier or an accounting staff (hereinafter referred to as “person in charge”) who collects sales proceeds from respective cash registers after business hours of the store, and deposits the sales proceeds into the valuable media management system S, so that the sales proceeds of the day are counted by the valuable media management system S and temporarily stored therein. In addition, the valuable media management system S is configured to dispense money, when money is needed such as when small change in the cash registers falls short.

The first machine 2 includes a box-like housing 4. An inlet 5 for banknotes, an outlet 6 for banknotes and a return slot 7 for banknotes are provided, in this order from the front side, in an upper surface of the box-like housing 4. In addition, a door 8 is provided on a front side surface of the housing 4. The door 8 is opened and closed when money is collected from the first machine 2, and when money is replenished to the first machine 2. In FIG. 1, the reference number 9 depicts a key hole by which the door 8 is locked and unlocked.

Similarly to the first machine 2, the second machine 102 includes a box-like housing 104. An inlet 105 for banknotes, an outlet 106 for banknotes and a return slot 107 for banknotes are provided, in this order from the front side, in an upper surface of the box-like housing 104. In addition, a door 108 is provided on a front side surface of the housing 104. The door 108 is opened and closed when money is collected from the second machine 102, and when money is replenished to the second machine 102. In FIG. 1, the reference number 109 depicts a keyhole by which the door 108 is locked and unlocked.

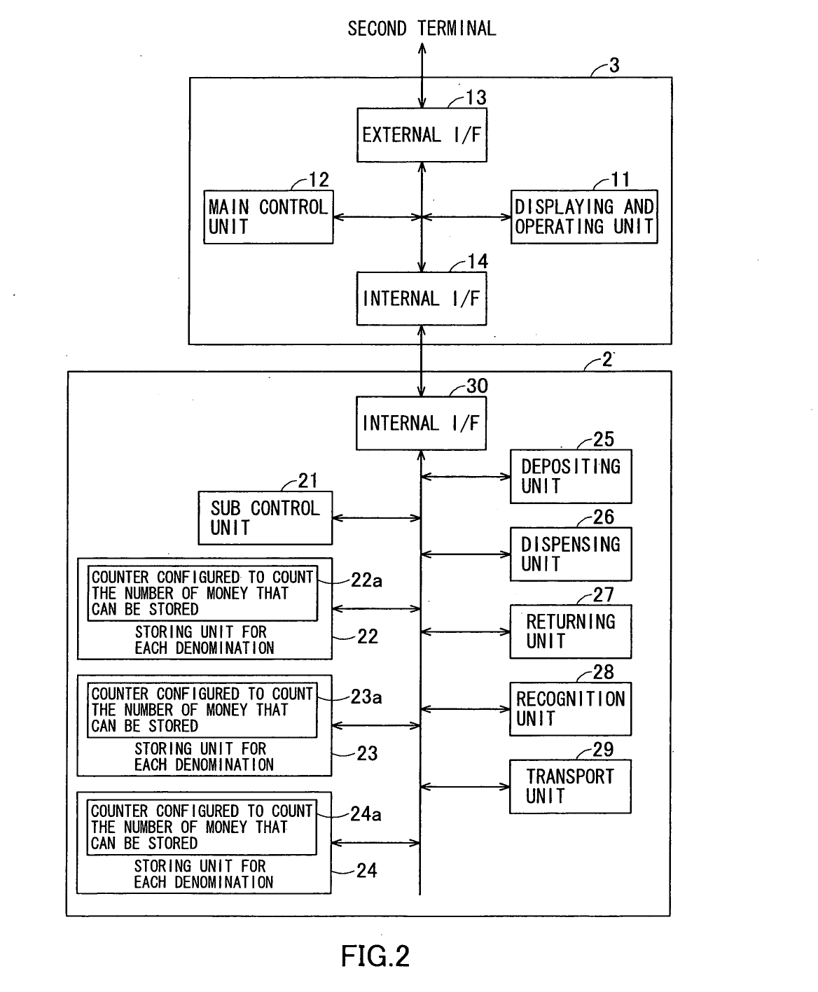

Inside each of the housings 4 and 104 of these first machine 2 and the second machine 102, there are respectively accommodated a sub control unit 21, storing units for each denomination 22 to 24, a depositing unit 25, a dispensing unit 26, a returning unit 27, a recognition unit 28, a transport unit 29, and an internal I/F (interface) 30 (see, FIG. 2), which will be described herebelow.

The first terminal 3 includes a body 10 accommodating a main control unit 12 (see, FIG. 2), which will be described below, and displaying and operating unit 11 of a touch-panel type. The displaying and operating unit 11 is configured to display images of various information about the first system 1, and to allow the first machine 2 to perform various operations such as a depositing process, a dispensing process and so on, when a predetermined position on an image screen is touched by a finger.

Similarly to the first terminal 3, the second terminal 103 includes a body 110 and a displaying and operating unit 111.

In the valuable media management system S in this embodiment, the first terminal 3 and the second terminal 103 are connected to each other through a communication cable 15, so that various information can be transmitted between the first terminal 3 and the second terminal 103.

With reference to FIG. 2, the structures of the first terminal 3 and the first machine 2 are described. FIG. 2 is a functional block view showing the structures of the first terminal 3 and the first machine 2. Since the first terminal 3 and the second terminal 103 have substantially the same structure, and the first machine 2 and the second machine 102 have substantially the same structure, detailed description of the second terminal 103 and the second machine 102 is omitted.

As shown in FIG. 2, the first machine 2 in this embodiment includes: the depositing unit 25 configured to take money deposited by a person in charge from the inlet 5 to the inside; the dispensing unit 26 configured to feed out money from the inside to the outlet 6; the returning unit 27 configured to return the money, once taken to the inside, through the return slot 7; the recognition unit 28 configured to recognize a kind of received money; the transport unit 29 configured to transport the money inside the first machine 2; the storing units for each denomination 22 to 24 configured to store money by denomination; the internal I/F 30 configured to send and receive various information to and from the first terminal 3; and the sub control unit 21 configured to control behaviors of the depositing unit 25, the dispensing unit 26, the returning unit 27, the recognition unit 28, the transport unit 29, the internal I/F 30, and the storing units for each denomination 22 to 24.

The depositing unit 25 functions as a valuable media receiving unit for receiving valuable media, based on a process command transmitted through the below-described internal I/F 30. The depositing unit 25 includes a pair of belts configured to sandwich money one by one from above and below, and a drive unit for driving the belts, the drive unit having pulleys and a motor. The depositing unit 25 is configured to take a plurality of money which have been collectively supplied into the inlet, to the inside one by one.

Similarly to the depositing unit 25, each of the dispensing unit 26 and the returning unit 27 includes a pair of belts and a drive unit for driving the belts, the drive unit having pulleys and a motor. The dispensing unit 26 is configured to feed out money one by one, which have been transported from the inside, to the outlet 6. The returning unit 27 is configured to return money one by one, which have been transported from the inside, through the return slot 7.

In this embodiment, based on an operation of the operation unit, the dispensing unit 26 functions as a discharging unit configured to discharge valuable media stored in the storing units.

The recognition unit 28 functions as a recognition unit for recognizing valuable media received by the valuable media receiving unit. The recognition unit 28 is configured to recognize a kind of banknotes deposited from outside, and to transmit the recognition result to the sub control unit 21.

To be specific, the recognition unit 28 includes an imaging unit configured to image money transported from the depositing unit. Based on an image of the money imaged by the imaging unit, the recognition unit 28 recognizes a kind of the money. Then, the recognition unit 28 transmits the recognition information to the sub control unit 21. Based on the recognition information transmitted from the recognition unit 28, the sub control unit 21 judges fitness of the money that has been recognized by the recognition unit 28, i.e., whether the money is a fit note or an unfit note, denomination of the money, i.e., whether the money is a 10,000-yen note, a 5,000-yen note or a 1,000-yen note, and authenticity of the money. Thereafter, the sub control unit 21 counts the number of the judged money for each denomination and a total sum thereof.

When valuable media is recognized by the recognition unit as valuable media incapable of being handled, the returning unit 27 functions as a returning unit configured to return the recognized valuable media. In this embodiment, based on a money recognition result by the recognition unit 28, when the sub control unit 21 judges that there is a counterfeit note among deposited money, the counterfeit note is retuned through the return slot 7.

The storing units for each denomination 22 to 24 function as storing units for storing valuable media recognized by the recognition unit. The storing units for each denomination 22 to 24 are formed of detachable stackers for storing money that have been recognized by the recognition unit 28 for each denomination (specifically, 10,000-yen note, 5,000-yen note and 1,000-yen note).

These storing units for each denomination 22 to 24 are equipped with counters 22a to 24a configured to count the number of money that can be stored in the respective storing units for each denomination 22 to 24 at the present moment.

Each of the counters 22a to 24a is configured to count the number of money that can be stored in the corresponding storing unit at the present moment, for each time when one money enters the corresponding stacker, by decreasing the number of money that can be stored in the empty stacker by a decrement of one, and functions as an example of a state detecting unit configured to detect the state of the first machine 2. In this embodiment, based on count values of the counters 22a to 24a, the main control unit 12 calculates the number of money that can be discharged at the present moment.

The transport unit 29 is configured to transport money from the depositing unit 25 to the storing units for each denomination 22 to 24 via the recognition unit 28; from the storing units for each denomination 22 to 24 to the dispensing unit 26 via the recognition unit 28; and from the depositing unit 25 to the returning unit 27 via the recognition unit 28.

The transport unit 29 includes a pair of transport belts extended between the respective units (depositing unit 25, dispensing unit 26, returning unit 27 and recognition unit 28) over a plurality of rollers, and a drive unit for driving the transfer belts. By driving the transfer belts with money being sandwiched one by one between the pair of transfer belts, the money can be transported one by one.

The sub control unit 21 includes a CPU (Central Processing Unit), a ROM (Read-Only Memory) and a RAM (Random Access Memory). When the CPU reads out various information processing programs for handling money, which are recorded in the ROM by the CPU, and execute the same, based on various process commands transmitted from the below-described main control unit 12, the sub control unit 21 controls behaviors of the depositing unit 25, the dispensing unit 26, the returning unit 27, the recognition unit 28 and transport unit 29 so as to perform the money depositing process, the money dispensing process, the money returning process and so on. The RAM functions as a temporal storage area that is used as a working area when the CPU executes the various information processing programs recorded in the ROM.

The reference number 30 in FIG. 2 depicts the internal I/F configured to send and receive various information including a process command, a deposit or dispense report, a return report and so on, to and from the first terminal 3.

The sub control unit 21, the internal I/F 30, the depositing unit 25, the dispensing unit 26, the returning unit 27, the recognition unit 28, the transport unit 29, and the storing units for each denomination 22 to 24 are connected to each other through an information communication bus.

In this embodiment, when the inside CPU executes the various information processing programs recorded in the ROM, the sub control unit 21 functions as a process command receiving unit configured to cooperate with the internal I/F 30 so as to receive a process command transmitted from the first terminal. Based on the process command transmitted from the first terminal, the sub control unit 21 totally controls operations of respective units constituting the first machine 2, such as the internal I/F 30, the depositing unit 25, the dispensing unit 26, the returning unit 27, the recognition unit 28, the transport unit 29, the storing units for each denomination 22 to 24, and so on.

Next, the structure of the first terminal 3 is described. The first terminal 3 includes an external I/F 13, which is configured to send and receive various information to and from the second terminal 103, an internal I/F 14, which is configured to send and receive various information to and from the first machine 2, the displaying and operating unit 11 of a touch-panel type, and the main control unit 12 configured to control the behavior of the first system 1 as a whole.

The main control unit 12 includes a CPU, a ROM and a RAM. The ROM records various information processing programs to be executed by the CPU, and information about various images to be displayed on the displaying and operating unit 11.

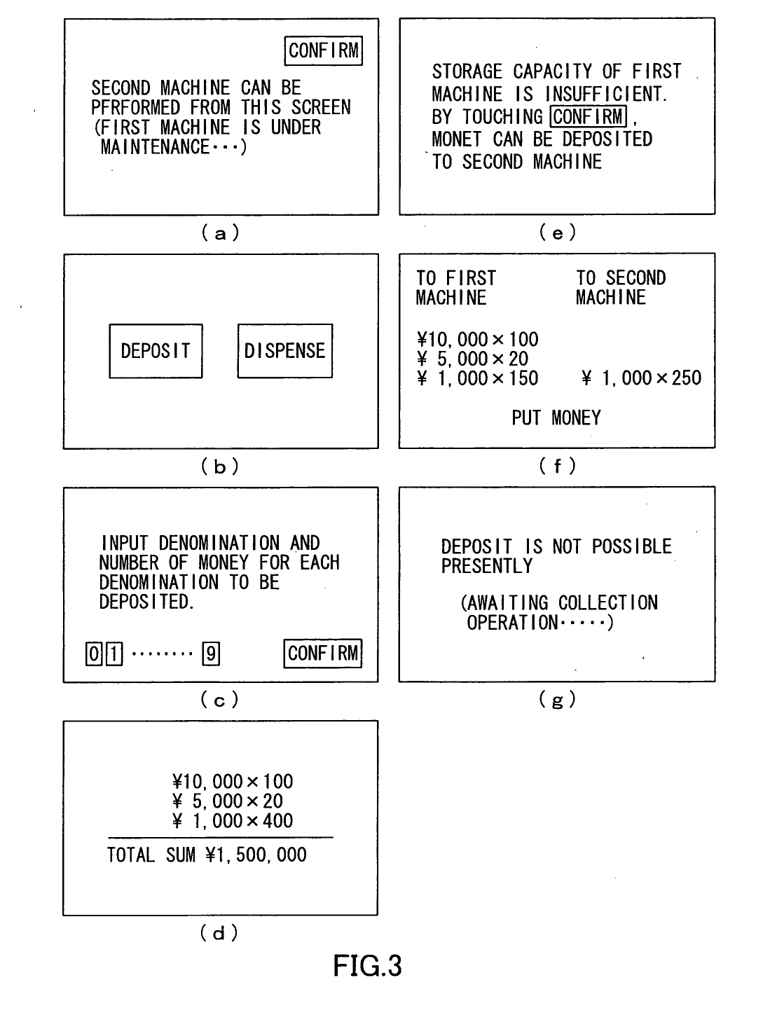

To be specific, the ROM records the various information processing programs to be executed by the CPU for transmitting various process commands, which include a money deposit start command and a money dispense start command, to the first machine 2, based on the operation of the displaying and operating unit 11, and information such as various guide display images (see, FIG. 3) for guiding a person in charge regarding an operation of the first terminal 3.

Based on an operation of the displaying and operating unit 11 by a person in charge, the main control unit 12 reads out the various information processing programs recorded in the ROM so as to execute the programs while using the RAM as a working area, so that control of the first system 1 as a whole, such as control of the work of the first machine 2 and control of the display of the displaying and operating unit 11, is performed.

The main control unit 12, the displaying and operating unit 11, the external I/F 13, and the internal I/F 14 are connected to each other through a communication bus.

In particular, the first terminal 3 has a corresponding machine control function for working the first machine 2 that corresponds to the own control unit (first terminal 3), as well as a non-corresponding machine control function for working the second machine 102 which is not the first machine 2 that corresponds to the own control unit.

Based on an operation of the displaying and operating unit 11 or an inside state (e.g., count values of the counters 22a to 24a) of the first machine 2, the first terminal 3 can switch the corresponding machine control function and the non-corresponding machine control function and set one of them.

That is to say, in the valuable media management system S in this embodiment, only by operating the displaying and operating unit 11 of the first terminal 3, a person in charge can deposit money to the first machine 2 and the second machine 102, and can dispense money form the first machine 2 and the second machine 102, without operating the displaying and operating unit 11 of the second terminal 103.

Thus, in addition to the aforementioned various information processing programs and the information about display images, the ROM of the main control unit 12 records: image information for announcing that money can be deposited to the second machine 102 by operating the first system 1 by the displaying and operating unit 11; an information processing program to be executed by the CPU for transmitting a process request from the first terminal 3 to the second terminal 103 so as to make the second machine 102 process money; and an information processing program to be executed by the CPU for receiving a process request from the second terminal 103 and for forwarding the process request as a process command to the first machine 2.

Further, the ROM of the main control unit 12 records: an information processing program to be executed by the CPU for detecting whether or not the first machine 2 should undergo a maintenance operation, such as collecting money from the first machine 2, replenishing money to the first machine 2, cancellation of an error when the error occurs in the first machine 2, checking operation, cleaning operation and so on; an information processing program to be executed by the CPU for obtaining the number of money that can be stored in the storing units for each denomination 22 to 24 of the first machine 2; and an information processing program to be executed by the CPU for obtaining the number of money that can be stored in the storing units for each denomination 22 to 24 of another handling machine such as the second machine 102.

When the aforementioned various kinds of information processing programs are executed by the CPU, the main control unit 12 serves as: a state detecting unit for detecting a state (e.g., the number of money that can be stored and so on) of the valuable media handling machine; a process command transmitting unit for transmitting a valuable-media process command to the valuable media processing machine that corresponds to the own control unit, based on an operation of the operation unit; a process request transmitting unit for transmitting, to another control unit, a process request requesting the valuable media handling machine, which corresponds to the other control unit, to process valuable media; a process request receiving unit for receiving a process request transmitted from another control unit; a process request forwarding unit for forwarding a process request as a process command, which has been received by the process request receiving unit, to the valuable media handling machine that corresponds to the own control unit; a storage possibility judgment unit for judging, when a valuable-media putting-in operation is performed by the operation unit, whether valuable media corresponding to the putting-in operation can be stored in the storing units or not; and a discharge possibility judgment unit for judging, when a valuable-media discharge operation is performed by the operating unit, whether valuable media corresponding to the discharge operation can be discharged or not.

Next, a series of flow of a depositing operation performed by a person in charge with the use of the first system 1 of the valuable media management system S as structured above is described with reference to FIG. 3. FIG. 3 is an explanatory view showing image examples displayed on the displaying and operating unit 11 of the first terminal 3 in the course of the depositing operation.

When a person in charge deposits money, as shown in FIG. 3(b), the displaying and operating unit 11 of the first terminal 3 displays an image by which the person in charge can select one of the depositing operation and the dispensing operation.

When the person in charge plans to perform the depositing operation, and when the first system 2 is under a state to be conducted a maintenance, the displaying and operating unit 11 displays a message announcing that the first system 2 is under maintenance, and a message announcing that an operation for depositing money to the second machine can be performed by operating the first terminal 3, as shown in FIG. 3(a). Herein, the state to be conducted a maintenance means a state that requires a money collection operation from the first machine 2 or a money replenishment operation to the first machine 2, a state that requires an error cancellation operation when the first machine 2 has an error, and a state that requires a checking and/or cleaning operation for the first machine 2.

Owing to such a display, the person in charge can perform the depositing operation, without moving between the systems, as well as the person in charge can easily know a handling machine (herein, the second machine 102) to which money can be deposited at present, whereby a burden on the person in charge during the depositing operation can be reduced.

Then, when the person in charge touches a portion on which the characters of “Deposit” are displayed in the image screen shown in FIG. 3(b), the displaying and operating unit 11 displays, as shown in FIG. 3(c), a deposit amount input command display image by which denomination and the number of money for each denomination to be deposited can be input.

For example, when the person in charge deposits one hundred 10,000-yen banknotes, twenty 5,000-yen banknotes, and four hundreds 1,000-yen banknotes, the person in charge suitably touches a portion on which the numerical symbols of 0 to 9 are displayed in a lower part of the image screen, and touches a portion on which the characters of “Confirm” are displayed for each time, so as to input the denomination and the number of the money for each denomination to be deposited. Then, the money corresponding to the inputted denominations and the number of money for each denomination is put into the inlet 5.

When the person in charge inputs the denominations and the number of money for each denomination to be deposited, as show in FIG. 3(d), the displaying and operating unit 11 displays the denomination and the number of money for each denomination, which have been inputted by the person in charge, and a total sum thereof (herein, 1,500,000 yen).

At this time, when the first machine 2 can store the entire sum of 1,500,000 yen, the money put into the inlet 5 is received by the first machine 2. Then, the money are recognized and judged, sorted depending on denomination, and thereafter sent to the storing units for each denomination 22 to 24, whereby the depositing process is completed.

However, there is a case in which, when the person in charge inputs the denomination and the number of money for each denomination to be deposited, the first machine 2 cannot store the entire sum of 1,500,000 yen, e.g., the first machine 2 can store only two hundreds of banknotes for each denomination any more. In this case, the first terminal in this embodiment searches another handling machine capable of storing the entire sum of money corresponding to the denomination and the number of money for each denomination to be deposited by the person in charge.

As a result of such a searching, when another applicable handling machine (e.g., the second machine 102) is detected, the displaying and operating unit 11 displays a display image for indicating the applicable handling machine, showing “Storage capacity of first machine is insufficient. By touching “Confirm”, money can be deposited to second machine”, as shown in FIG. 3(e).

Then, the person in charge touches the characters of “Confirm” on the display image for indicating the applicable handling machine, and puts the money into the inlet 105 of the second machine 102 in accordance with the guidance of the display image for indicating the applicable handling machine. Then, the money are recognized and judged, sorted depending on denomination, and thereafter sent to the storing units for each denomination 22 to 24, whereby the depositing operation is completed.

In this manner, when the first terminal 2 corresponding to the first terminal 3 on which the depositing operation is performed cannot store the entire sum of money corresponding to the depositing operation, the first terminal 3 in this embodiment searches another handling machine capable of storing the entire sum of money. When there is another applicable handling machine (herein, the second machine 102), the displaying and operating 11 informs the person in charge of the applicable handling machine by showing the same.

Thus, the person in charge can deposit the money to the second machine 102, by continuously operating the first terminal 3, without operating the second terminal 103. As a result, a burden on the person in charge during the depositing operation can be reduced.

In addition, when it is found that there is no applicable handling machine after searching another handling machine capable of storing the entire sum of money corresponding to the denomination and the number of money for each denomination to be deposited by the person in charge, the first terminal 3 in this embodiment judges whether the money can be dividedly stored in a plurality of handling machines.

That is to say, the first terminal 3 searches a handling machine that cannot store the entire sum of money corresponding to the denomination and the number of money for each denomination to be deposited by the person in charge, but can store a part thereof.

As a result of such a searching, when a plurality of applicable handling machines are detected, and a total of money for each denomination that can be stored in the respective applicable handling machines is larger than the number of money for each denomination to be deposited, the displaying and operating unit 11 displays a display image for informing the person in charge of the applicable handling machines (herein, the first machine 2 and the second machine 102) into which the money to be deposited are dividedly putted, as shown in FIG. 3(f).

In accordance with the guidance of the display image for indicating the applicable handling machines, the person in charge puts the money into the first machine 2 and the second machine 102. Then, the money are recognized and judged, the sorted depending on denomination, and thereafter sent to the storing units for each denomination 22 to 24, whereby the depositing operation is completed.

In this manner, in a case the person in charge deposits money whose number is so large that another handling machine cannot store the money by itself, but the money can be dividedly stored in a plurality of handling machines (herein, the first machine 2 and the second machine 102), the first terminal 3 informs the person in charge of the number of money for each denomination to be inputted into the respective handling machines.

Thus, the person in charge can dividedly deposit the money to the first machine 2 and the second machine 102, by continuously operating the first terminal 3, without operating the second terminal 103. As a result, a burden on the person in charge during the depositing operation can be reduced.

Alternatively, when the first terminal 3 in this embodiment judges that the entire sum of money corresponding to the denomination and the number of money for each denomination to be deposited by the person in charge cannot be stored even by the plurality of handling machines, the first terminal 3 displays a guide image showing “Deposit is not possible presently (awaiting collection operation)” on the displaying and operating unit 11, as shown in FIG. 3(g).

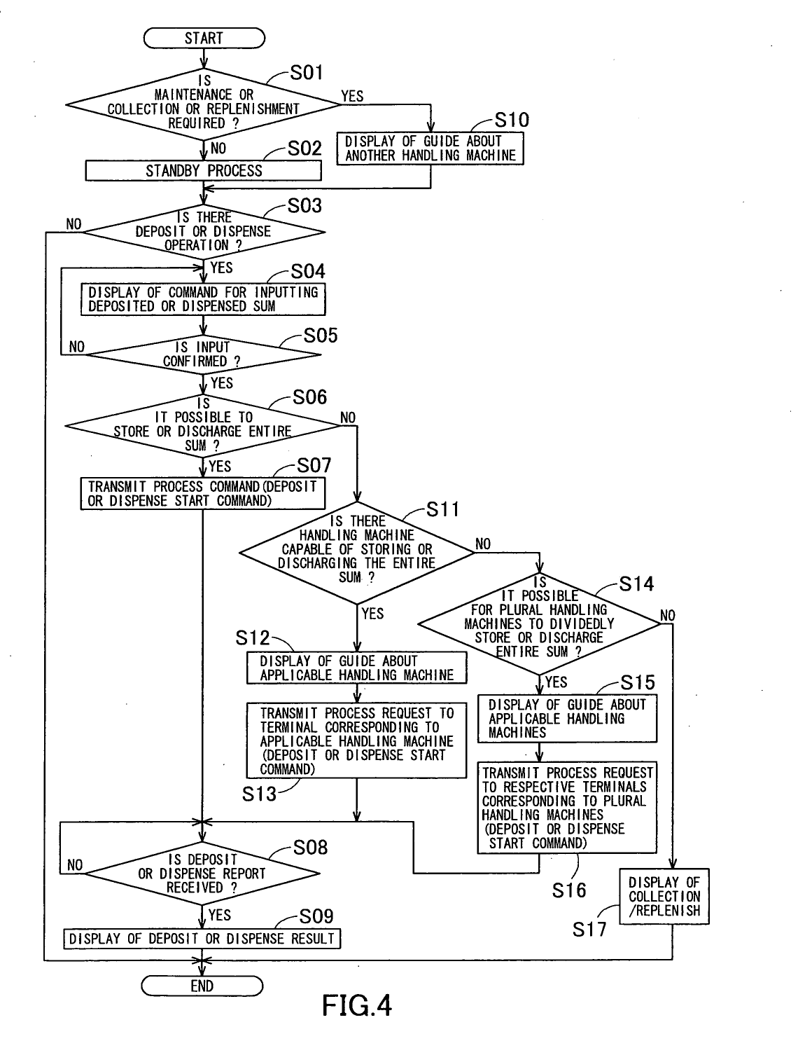

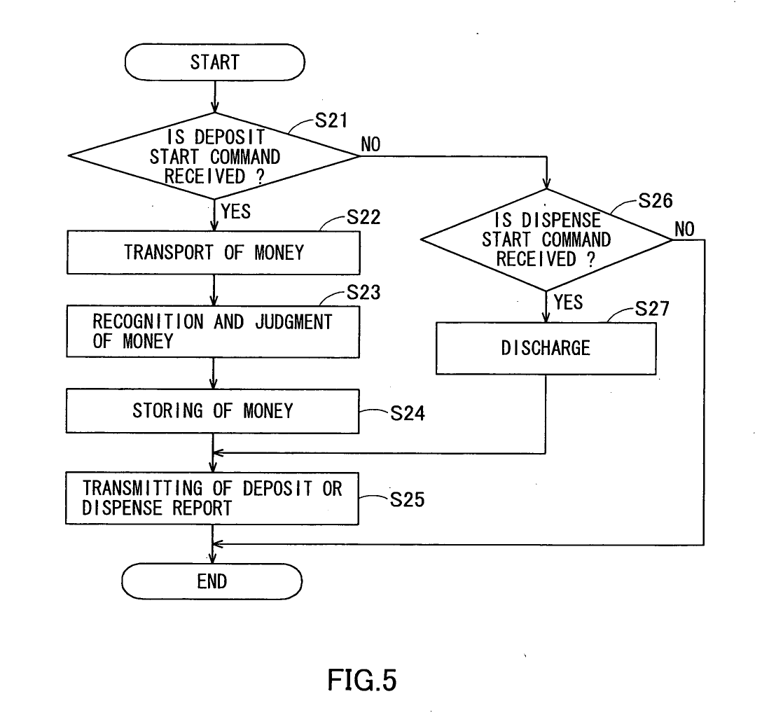

Next, processes performed in the first system 1 when the aforementioned series of operations are performed are described with reference to FIGS. 4 and 5.

At first, processes performed by the main control unit 12 of the first terminal 3 are described with reference to a flowchart shown in FIG. 4. In this embodiment, since the first system 1 and the second system 100 have the same structure, processes performed by the control unit of the second system 100 is omitted.

FIG. 4 is the flowchart showing the processes performed by the main control unit 12. While electric power is being supplied to the valuable media management system S, the main control unit 12 repeatedly performs the series of processes shown in the flowchart of FIG. 4.

When electric power is supplied to the valuable media management system S, the main control unit 12 of the first terminal 3 (hereafter referred to simply as “main control unit 12”) firstly judges whether the first machine 2 is under the state to be conducted a maintenance, or whether money should be collected or not, or whether money should be replenished or not (step S01), by referring to count values of the counters 22a to 24a or a working condition of the CPU. The state to be conducted a maintenance means a state that requires an error cancellation operation when the first machine 2 has an error, and a state that requires a checking and/or cleaning operation for the first machine 2. These operations described herein are mere examples. In addition to the above states, the state to be conducted a maintenance may include a state that requires any maintenance operation that can be assumed for the first machine 2, such as a state that requires a replacement operation of consumable parts inside the first machine 2.

In the step S01, when the main control unit 12 judges that any one of the maintenance operation, the money collection operation and the money replenishment operation is required for the first machine 2 (step S01: Yes), the main control unit 12 advances the process to a step S10. Then, the main control unit 12 displays the guide image (see, FIG. 3(a)) for guiding the person in charge about another handling machine (second machine 102), and advances the process to a step S03.

On the other hand, in the step S01, when the main control unit 12 judges that none of the maintenance operation, the money collection operation and the money replenishment operation is required for the first machine 2 (step S01: No), the main control unit 12 advances the process to a step S02.

Then, in the step S02, the main control unit 12 performs a standby process. In the standby process, the main control unit 12 performs a process in which the displaying and operation unit 11 displays, as a standby image, the image by which one of the depositing process or the dispensing operation can be selected by a person in charge (see, FIG. 3(b)). Thereafter, the main control unit 12 advances the process to a step S03.

Then, in the step S03, the main control unit 12 judges whether an operation for performing the depositing process (hereinafter referred to as “depositing operation”) or an operation for performing the dispensing process (hereinafter referred to as “dispensing operation”) is performed. In the below description, when the depositing operation and the dispensing operation are not discriminated from each other, these operations are generically referred to as “depositing or dispensing operation”.

When the main control unit 12 detects that the person in charge has touched the portion on which the characters of “Deposit” or “Dispense” in the standby image displayed on the displaying and operating unit 11, the main control unit 12 judges that the depositing or dispensing operation has been performed.

In the step S03, when the main control unit 12 judges that the depositing or dispensing operation has not been performed (step S03: No), the main control unit 12 finishes the process. On the other hand, when the main control unit judges that the depositing or dispensing operation has been performed (step S03: Yes), the main control unit 12 advances the process to a step S04.

In the step S04, the main control unit 12 performs a process in which a display image for commanding the person in charge to input the denomination and the number of money for each denomination to be deposited or dispensed on the displaying and operating unit 11.

When an operation of the person in charge detected in the step S03 is the depositing operation, the main control unit 12 displays, on the displaying and depositing unit 11, the message of “Input denomination and number of money for each denomination to be deposited”, and the characters of “Confirm”, as shown in FIG. 3(c).

Then, in a step S05, the main control unit 12 judges whether the input of the denomination and the number of money for each denomination to be deposited or dispensed has been confirmed by the person in charge or not. When the main control unit 12 detects that the person in charge has touched the portion on which the numerical symbols of 0 to 9 are displayed in the display image for commanding the person in charge to input the denomination and the number of money for each denomination to be deposited or dispensed, so as to input the denomination and the number of money for each denomination to be deposited or dispensed, and that the person in charge has touched the portion on which the characters of “Confirm” is displayed, the main control unit 12 judges that the input has been confirmed.

Then, when the main control unit 12 judges that the input of the denomination and the number of money for each denomination to be deposited or dispensed has been confirmed in the step S03 (step S05: Yes), the main control unit 12 advances the process to a step S06. On the other hand, when the main control unit 12 judges that the input of the denomination and the number of money for each denomination to be deposited or dispensed has not been confirmed (step S05: No), the main control unit 12 repeatedly performs the judgment process in the step S05 until the input is confirmed.

Then, in the step S06, when the sum of money confirmed in the step S05 is a sum of money to be deposited, the main control unit 12 obtains count values of the counters 22a to 24a, and judges whether the entire sum of money to be deposited can be stored in the first machine 2 based on the count values. When the main control unit 12 judges that the entire sum of money can be stored (step S06: Yes), the main control unit 12 sets the corresponding machine control function, and advances the process to a step S07. On the other hand, when the main control unit 12 judges that the entire sum of money cannot be stored (step S06: No), the main control unit 12 advances the process to a step S11.

Meanwhile, in the step S06, when the sum of money confirmed in the step S05 is a sum of money to be dispensed, the main control unit 12 obtains count values of the counters 22a to 24a, and judges whether the entire sum of money to be dispensed can be discharged from the first machine 2 based on the count values. When the main control unit 12 judges that the entire sum of money can be discharged (step S06: Yes), the main control unit 12 sets the corresponding machine control function, and advances the process to the step S07. On the other hand, when the main control unit 12 judges that the entire sum of money cannot be discharged (step S06: No), the main control unit 12 advances the process to the step S11.

Then, in the step S07, the main control unit 12 transmits a process command including a deposit or dispense start command to the first machine 2.

At this time when the sum of money confirmed in the step S05 is a sum of money to be deposited, the main control unit 12 transmits a process command for commanding a start of the depositing process to the first machine 2. On the other hand, when the sum of money confirmed in the step S05 is a sum of money to be dispensed, the main control unit 12 transmits a process command for commanding a start of the dispensing process to the first machine 2. Thereafter, the main control unit 12 advances the process to a step S08.

In the step S11, the main control unit 12 judges whether or not there is another handling machine (herein, the second machine 102) that is not the first machine 2 and can store or discharge the entire sum of money to be deposited or dispensed, which has been confirmed in the step S05.

When the sum of money confirmed in the step S05 is a sum of money to be deposited, the main control unit 12 obtains count values of the counters 22a to 24a, and judges whether the second machine 102 can store the entire sum of money to be deposited based on the count values. When the main control unit 12 judges that the entire sum of money can be stored (step S11: Yes), the main control unit 12 sets the non-corresponding machine control function, and advances the process to a step S12. On the other hand, when the main control unit 12 judges that the entire sum of money cannot be stored (step S11: No), the main control unit 12 advances the process to a step S14.

Meanwhile, when the sum of money confirmed in the step S05 is a sum of money to be dispensed, the main control unit 12 obtains count values of the counters 22a to 24a, and judges whether the second machine 102 can discharge the entire sum of money to be dispensed based on the count values. When the entire sum of money can be discharged (step S11: Yes), the main control unit 12 sets the non-corresponding machine control function, and advances the process to the step S12. On the other hand, when the main control unit 12 judges that the entire sum of money cannot be discharged (step S11: No), the main control unit 12 advances the process to a step S14.

In the step S12, the main control unit 12 performs a process in which the image (see, FIG. 3(e)) for guiding the person in charge about the applicable handling machine (herein, the second machine 102) is displayed on the displaying and operating unit 11. Then, the main control unit 12 advances the process to a step S13.

Then, in the step S13, the main control unit 12 transmits a process request including deposit or dispense start command, to a terminal (herein, the second terminal 103) corresponding to the applicable handling machine (herein, the second machine 102). Then, the main control unit 12 advances the process to a step S08.

At this time, when the sum of money confirmed in the step S05 is a sum of money to be deposited, the main control unit 12 transmits a process request including a deposit start command to the second terminal 2. On the other hand, when the sum of money confirmed in the step S05 is a sum of money to be dispensed, the main control unit 12 transmits a process request including a dispense start command to the second terminal 2. Then, the main control unit 12 advances the process to the step S08.

In addition, in the step S14, the main control unit 12 judges whether the sum of money confirmed in the step S05 can be stored or discharged dividedly by a plurality of handling machines (herein, the first machine 2 and the second machine 102).

When the sum of money confirmed in the step S05 is a sum of money to be deposited, the main control unit 12 obtains count values of the counters 22a to 24a of the first machine 2 and the second machine 102. When the main control unit 12 judges that the sum of money to be deposited, which has been confirmed in the step S05, can be stored dividedly in the first machine 2 and the second machine 102 based on the count values (step S14: Yes), the main control unit 12 sets both of the corresponding machine control function and the non-corresponding machine control function, and advances the process to a step S15. On the other hand, when the control unit 12 judges that the sum of money to be deposited cannot be stored (step S14: No), the main control unit 12 advances the process to a step S17.

Meanwhile, when the sum of money confirmed in the step S05 is a sum of money to be dispensed, the main control unit 12 obtains count values of the counters 22a to 24a of the first machine 2 and the second machine 102. When the main control unit 12 judges that the sum of money to be dispensed, which has been confirmed in the step S05, can be discharged dividedly from the first machine 2 and the second machine 102 based on the count values (step S14: Yes), the main control unit sets both of the corresponding machine control function and the non-corresponding machine control function, and advances the process to the step S15. On the other hand, when the control unit 12 judges that the sum of money to be dispensed cannot be discharged (step S14: No), the main control unit 12 advances the process to the step S17.

In the step S15, the main control unit 12 performs a process in which a guide display image for guiding the person in charge about the applicable handling machines (herein, the first machine 2 and the second machine 102) is displayed on the displaying and operating unit 11. Then, the main control unit 12 advances the process to a step S16.

Then, in the step S16, the main control unit 12 transmits a command request including a deposit or dispense start command to each terminal (herein, the second terminal 103) corresponding to the plurality of handling machines (herein, the first machine 2 and the second machine 102).

Herein, since the money depositing or dispensing process is dividedly performed by the first machine 2 corresponding to the first terminal 3 and the second machine 102 corresponding to the second terminal 103, the main control unit 12 transmits a process request including a deposit or dispense start command, only to the second terminal 103, and does not transmit a process request to the own control unit (first terminal 3). Instead of this, the main control unit 12 transmits a process command including a deposit or dispense start command to the first machine 2.

When the sum of money confirmed in the step S05 is a sum of money to be deposited, the main control unit 12 transmits a process request including a deposit start command to the second terminal 103, and transmits a process request including a deposit start command to the first machine 2. Then, the main control unit 12 advances the process to the step S08.

Meanwhile, when the sum of money confirmed in the step S05 is a sum of money to be dispensed, the main control unit 12 transmits a process request including a dispense start command to the second terminal 103, and transmits a process request including a dispense start command to the first machine 2. Then, the main control unit 12 advances the process to the step S08.

In the step S17, since the sum of money to be deposited or dispensed confirmed in the step S05 cannot be stored or discharged even by the plurality of handling machines, the main control unit 12 displays, on the displaying and operating unit 11, a collection and replenishment display image (see, FIG. 3(g), for example) showing that collection or replenishment of money is required. Thereafter, the main control unit 12 finishes the process.

In addition, in the step S08, the main control unit 12 judges whether or not a deposit or dispense report (a deposit report or a dispense report) is transmitted from any of the handling machines (herein, the first machine 2 and the second machine 102).

Herein, when the main control unit 12 judges that a deposit or dispense report has been received (step S08: Yes), the main control unit 12 advances the process to a step S09. On the other hand, when the main control unit 12 judges that a deposit or dispense report has not been received (step S08: No), the main control unit 12 repeatedly performs the judgment process of the step S08 until a deposit or dispense report is received.

Finally, in the step S09, the main control unit 12 displays, on the displaying and operating unit 11, the image indicating contents of the deposit or dispense report which has been received in the step S08. Then, the main control unit 12 records the contents in a record unit inside the main control unit 12, and finishes the process.

Next, processes performed by the sub control unit 21 that controls the first machine 2 of the first system 1 are described with reference to FIG. 5. FIG. 5 is a flowchart showing the processes performed by the sub control unit 21 of the first machine 2. In this embodiment, since the first system and the second system 102 have the same structure, processes performed by the sub control unit of the second system 102 are omitted.

While electric power is being supplied, the sub control unit 21 of the first machine 2 repeatedly performs the series of processes shown in the flowchart of FIG. 5.

The sub control unit 21 of the first machine 2 (hereinafter referred to simply as “sub control unit 21”) judges whether a process command including a deposit start command or a process request including the same from the first terminal 3 or the second terminal 103 has been received (step S21). When the sub control unit 21 judges that a process command including a deposit start command or a process request including the same has been received (step S21: Yes), the sub control unit 21 advances the process to a step S22. When the sub control unit 21 judges that a process command including a deposit start command or a process request including the same has not been received (step S21: No), the sub control unit 21 advances the process to a step S26.

Then, in the step S22, the sub control unit 21 operates the depositing unit 25 and the transport unit 29 so as to start a process in which money put through the inlet 5 is transferred to the recognition unit 28, and thereafter the sub control unit 21 advances the process to a step S23. The operation of the depositing unit 25, which is started at this time, finishes at a time when all the money put into the inlet 5 have been sent to the transport unit 29. The operation of the transport unit 29 finishes at a time when all the deposited money have been stored or returned.

Then, in the step S23, the sub control unit 21 performs a process in which fitness, denomination and so on of the deposited money are recognized and judged based on a money recognition result of the recognition unit 28, and the number of the deposited money for each denomination and a total sum thereof are counted. Thereafter, the sub control unit 21 advances the process to a step S24.

Then, in the step S24, the sub control unit 21 performs a process in which the money that have been subjected to the recognition and judgment process and the counting process in the step S23 are sent to the storing units for each denomination 22 to 24 depending on their denomination so as to be stored therein. Thereafter, the sub control unit 21 advances the process to a step S25.

In addition, in the step S26, the sub control unit 21 judges whether a process command including a dispense start command from the first terminal 3 or the second terminal 103 has been received. When the sub control unit 21 judges that a process command including a dispense start command has been received (step S26: Yes), the sub control unit 21 advances the process to a step S27. On the other hand, when the sub control unit 21 judges that a process command including a dispense start command has not been received (step S26: No), the sub control unit 21 finishes the process.

Then, in the step S27, the sub control unit 21 performs a process in which money corresponding to the dispense command are fed out from the storing units for each denomination 22 to 24 to the dispensing unit 26. Thereafter, the sub control unit 21 advances the process to a step S25.

Finally, in the step S25, the sub control unit 21 transmits a deposit or dispense report to the first terminal 3, and finishes the process.

The deposit or dispense report transmitted at this time includes, when the money was stored, the number of the stored money for each denomination and a total sum thereof, and when the money was dispensed, the number of the dispensed money for each denomination and a total sum thereof.

In the above-described embodiment, when a person in charge performs a depositing operation or a dispensing operation, denomination and the number of the money for each denomination to be deposited or dispensed have to be inputted. However, when a depositing operation or a dispensing operation is performed, it is possible to input only a deposit sum or a dispense sum.

In this case, a terminal on which a depositing operation or a dispensing operation is performed performs a simulation in which money whose sum corresponding to the maximum number of money is deposited, or money whose sum corresponding to the maximum number of money is dispensed. Based on the simulation result and count values of the counters 22a to 24a of respective handling machine, the terminal guides a person in charge about a handling machine capable of performing a depositing operation or a dispensing operation.

In addition, in this case, an information processing program for executing the simulation is recorded in the ROM of the main control unit 12.

In addition, the present invention can be applied to a valuable media management system including a plurality of valuable media management apparatuses, in which at least one of a plurality of valuable media handling machines has a valuable media processing function that is the same as that of other valuable media handling machine.

Even when the present invention is applied to such a valuable media management system, by operating one control unit, other valuable media handling machine having the same valuable media processing function can be operated. Thus, even when there are provided a plurality of valuable media management apparatuses having the same processing function, the present invention can provide a valuable media management system capable of restraining increase of a burden on a person in charge.

The aforementioned various information processing programs are not necessarily recorded in the ROM from the first. The respective information processing programs may be recorded in: a “movable physical medium” such as a flexible disc (FD), a CD-ROM, an MO disc, a DVD disc, a magnetoptical disc, or an IC card, which can be inserted to respective terminals and the respective deposit and dispense apparatuses; a “stationary physical medium” such as a hard disc drive (HDD) which can be installed inside or outside the respective terminals and the respective deposit and dispense apparatuses; or “another computer (or a server)” connected to the respective terminals and the respective deposit and dispense apparatuses through a public circuit, an Internet, a LAN or a WAN. The respective information processing programs recorded in such media or computer may be read by the computer and executed.

Out of the respective processes described in this embodiment, a part of or all of the processes which are described as the automatic processes may be manually performed. Alternatively, a part of or all of the processes which are described as the manual processes may be automatically performed by a known method. Moreover, unless otherwise specified, the process procedure, the control procedure, the concrete names, and the information including various data and parameters, may be optionally changed.

Further, the illustrated respective constituent elements of the apparatuses are functional and conceptual, and it is not necessary that the constituent elements are physically structured as the illustration. Namely, the concrete form of dispersion and integration of the respective apparatuses is not limited to the illustrated examples, but all or one of the apparatuses can be functionally or physically dispersed and integrated at optional unit in accordance with various loads and used conditions. Furthermore, all or an optional part of the respective process functions performed in the respective apparatuses may be realized by a CPU and an information processing program that is analyzed and executed by the CPU, or may be realized as a hardware by a wired logic.

1. A valuable media management system comprising a plurality of valuable media management apparatuses each including: a valuable media handling machine configured to process valuable media; and a control unit that corresponds to the valuable media handling machine, the control unit having an operation unit configured to be operated for working the valuable media handling machine;
wherein:
at least one valuable media handling machine among the plurality of valuable media handling machines has a valuable-media processing function that is the same as that of another valuable media handling machine;
each of the valuable media handling machine has a state detecting unit configured to detect a state of the valuable media handling machine; and
each of the control unit has a corresponding machine control function for working the valuable media handling machine that corresponds to the own control unit, as well as a non-corresponding machine control function for working another valuable media handling machine other than the valuable media handling machine that corresponds to the own control unit, and the corresponding machine control function and the non-corresponding machine control function are capable of being switched depending on a change of the state of the valuable media handling machine detected by the state detecting unit.

2. The valuable media management system according to claim 1, wherein:
when the corresponding machine control function is set, the control unit transmits a process command to the valuable media handling machine that corresponds to the own control unit, such that valuable media are processed by the valuable media handling machine; and
when the non-corresponding machine control function is set, the control unit transmits a process request to another control unit, such that valuable media are processed by the valuable media handling machine that corresponds to said other control unit.

3. The valuable media management system according to claim 2, wherein
when the control unit receives the process request transmitted from another control unit, the control unit allows the valuable media handling machine that corresponds to the own control unit to be worked by said other control unit that has transmitted the process request.

4. The valuable media management system according to claim 1, wherein
the valuable media handling machine includes:
a valuable media receiving unit configured to receive valuable media;
a recognition unit configured to recognize the valuable media received by the valuable media receiving unit; and
a storing unit configured to store the valuable media recognized by the recognition unit.

5. The valuable media management system according to claim 1, wherein
the control unit is configured to be capable of switching the corresponding machine control function and the non-corresponding machine control function, based on an operation of the operation unit.

6. The valuable media management system according to claim 4, wherein
the state detecting unit is configured to detect the number of valuable media stored in the storing unit, as a state of the valuable media handling machine.

7. The valuable media management system according to claim 6, wherein:
the control unit includes a storage possibility judgment unit configured to judge whether valuable media to be put into the valuable media handling machine that corresponds to the own control unit are capable of being stored in the storing unit; and
when the storage possibility judgment unit judges that the valuable media are not capable of being stored, the control unit transmits a process request, requesting storage of the valuable media, to the control unit that corresponds to another valuable media handling machine capable of storing the valuable media.

8. The valuable media management system according to claim 7, wherein
the control unit includes an informing unit configured to inform of the other valuable media handling machine capable of storing the valuable media, when the storage possibility judgment unit judges that the valuable media are not capable of being stored.

9. The valuable media management system according to claim 4, wherein:
the valuable media handling machine includes a discharge unit configured to discharge valuable media stored in the storing unit, the valuable media being discharged based on an operation of the operation unit;
the control unit includes a discharge possibility judgment unit configured to judge, when a discharge operation for discharging valuable media is performed by the operation unit, whether valuable media corresponding to the discharge operation are capable of being discharged or not; and
when the discharge possibility judgment unit judges that the valuable media are not capable of being discharged, the control unit transmits a process request requesting discharge of valuable media to the control unit that corresponds to another valuable media handling machine capable of discharging valuable media corresponding to the discharge operation.

10. The valuable media management system according to claim 9, wherein
the control unit includes an informing unit configured to inform of the other valuable media handling machine capable of discharging the valuable media corresponding to the discharge operation, when the discharge possibility judgment unit judges that the valuable media are not capable of being discharged.

11. The valuable media management system according to claim 1, wherein:
the state detecting unit detects whether the valuable media handling machine should undergo a maintenance operation or not, and
when the state detecting unit detects that the valuable media handling machine should undergo a maintenance operation, the control unit informs of another valuable media handling machine that does not require a maintenance operation.

12. A valuable media management method comprising:
controlling a corresponding machine, by means of a control unit that corresponds to a valuable media handling machine configured to process valuable media and controls a behavior of the valuable media handling machine, to process valuable media by the valuable media handling machine that corresponds to the control unit;
controlling a non-corresponding machine, by means of the control unit, to process valuable media by another valuable media handling machine having the same valuable-media processing function as that of the valuable media handling machine; and
switching the controlling of a corresponding machine and the controlling of a non-corresponding machine by the control unit depending on a state of the valuable media handling machine that corresponds to the control unit.
